(19) United States
(12) Patent Application Publication
(10) Pub. No.: US 2026/0048550 A1
(43) Pub. Date: Feb. 19, 2026

(54) SYSTEM AND METHOD FOR PRINTING A THREE-DIMENSIONAL OBJECT

(71) Applicant: Robert Bosch GmbH, Stuttgart (DE)

(72) Inventor: Hendrik Jahnle, Leutenbach (DE)

(21) Appl. No.: 19/103,838

(22) PCT Filed: Sep. 19, 2023
(86) PCT No.: PCT/EP2023/075839

§ 371 Date: Feb. 14, 2025

(30) Foreign Application Priority Data
Sep. 22, 2022 (DE) 10 2022 210 001.8

(51) Int. Cl. B29C 64/386; B29C 64/343; B33Y 10/00; B33Y 30/00; B33Y 40/00; B33Y 50/00

(52) U.S. Cl. CPC B29C 64/386; B29C 64/343; B33Y 10/00; B33Y 30/00; B33Y 40/00; B33Y 50/00

(57) ABSTRACT

A system for printing a three-dimensional object from a printable material. The system includes a printing device for a 3D printer, a dosing device for filling the material to be printed and a discharge device for printing the material provided via the dosing device. The discharge device includes a first marking device for identifying the printable material and/or the three-dimensional object. A method for printing a three-dimensional object from a printable material by means of the system is also described.

### FIELD

The present invention relates to a system and a method for printing a three-dimensional object.

### BACKGROUND INFORMATION

A 3D printer for a material with a variable viscosity receives a solid phase of this material as a starting material, creates a liquid phase from it and selectively applies this liquid phase to the places that belong to the object to be generated. Such a 3D printer comprises a print head in which the starting material is prepared for printing. The material is transported further via channels in the print head.

Furthermore, means are provided for generating a relative movement between the print head and the work surface on which the object is to be created. Either only the print head, only the work surface or both the print head and the work surface can be moved. In order to influence the discharge of the material onto the work surface, an actuator is usually provided in the print head, which applies a force to a dosing zone.

PCT Patent Application No. WO 2018/086792 A1 describes a print head for a 3D printer. The print head comprises a feeder, via which a raw material to be printed is fed to the print head. This raw material is melted and plasticized in the print head. This molten material is transported within the print head to an exit opening, via which this material is applied to a print region.

Germany Patent Application No. DE 10 2019 219 083 A1 describes a printing device comprising a dosing device for melting and plasticizing a material to be printed and a discharge device for printing the material provided via the dosing device. The dosing device and the discharge device are arranged separately from one another and can be connected to one another, wherein the discharge device can be transported to the dosing device in order to receive material, and a nozzle of the discharge device and a coupling point of the dosing device come into contact with one another in order to connect the discharge device to the dosing device.

An object of the present invention is to provide a system and a method for printing a three-dimensional object that allow printing from a discharge device, wherein material and/or object properties of a material to be printed can be clearly allocated to a discharge device.

### SUMMARY

Within the framework of the present invention, a system for printing a three-dimensional object from a printable material is provided. According to an example embodiment of the present invention, the system comprises a printing device for a 3D printer, a dosing device for filling the material to be printed and a discharge device for printing the material provided via the dosing device.

According to an example embodiment of the present invention, the discharge device comprises a first marking device for identifying the printable material and/or the three-dimensional object.

The material properties, in particular in plastics 3D printing, have a major influence on the quality and function of the finished component and the printing process must be adapted and validated accordingly with respect to different starting materials, in order to ensure a high quality of the finished component.

The identification of the printable material and/or the three-dimensional object ensures that the correct material is in the particular discharge device and/or that the correct object data are assigned to the discharge device. Incorrect material or incorrect object data can be detected in an advantageous manner, as a result of which a reliable printing process can be ensured.

The marking device on the discharge device advantageously allows easy identification of the printable material and/or the three-dimensional object to the discharge device.

The discharge device can also be referred to as a cartridge or print cartridge. After the discharge device has been filled with the printable material via a dosing device, it can be transported to the printing device after being filled with the material. The printing device is a printer or a print head. The dispensing device or cartridge advantageously allows the material in the cartridge to retain a consistent residual moisture or dryness during storage or transport. The material also cannot become contaminated and penetration of moisture is avoided.

In a development of the present invention, the dosing device comprises a second marking device. The marking device on the dosing device advantageously allows communication with the first marking device of the discharge device.

In a development of the present invention, the printing device comprises a third marking device. The marking device on the printing device advantageously allows communication with the first marking device of the discharge device.

It is advantageous if the material is provided as bulk material, in particular as granules.

In a development of the present invention, the system is designed in such a way that process data of the printable material and/or the three-dimensional object can be clearly assigned to the particular discharge device.

According to an example embodiment of the present invention, the process data comprise validated characteristics of the material and/or the component that increase the print or print quality.

The clear assignment of the process data of the printable material and/or the three-dimensional object to the particular discharge device advantageously simplifies the identification of the printable material and/or the three-dimensional object to the discharge device.

In a first example embodiment of the present invention, the process data are stored in a storage unit of the first marking device, wherein the storage unit is arranged on the discharge device.

Storing the process data on a storage unit of the discharge device advantageously allows the process parameters to be directly assigned to the particular discharge device. Advantageously, the data can be read out directly from the storage unit. Thus, features related to printing are located directly on the cartridge.

In a second example embodiment of the present invention, the process data are stored in a network or in a cloud, wherein they can be assigned to the particular printable material and/or the three-dimensional object via an identification code stored on the first marking device.

Storing the process data in a network or in a cloud advantageously allows secure storage of the data. Direct assignment of the process parameters to the particular discharge device is possible by means of the identification code stored on the first marking device. Advantageously, the data can be loaded from the network or cloud and, if applicable, processed without physical contact.

In a development of the present invention, the first marking device of the discharge device is suitable for mutual communication with the second marking device of the dosing device and for mutual communication with the third marking device of the printing device, as a result of which communication between the first marking device of the discharge device and the second marking device of the dosing device and/or the third marking device of the printing device can advantageously take place. For this purpose, the first marking device can be designed to be read out optically or via a receiver unit for wireless communication. This allows the process data to be read out easily and securely.

Furthermore, according to an example embodiment of the present invention, the first marking device can comprise a QR code or a barcode, as a result of which the discharge device can be easily and reliably identified.

Furthermore, according to an example embodiment of the present invention, the marking device can be designed in such a way that process data can be transmitted via WLAN, RFID, NFC, Bluetooth or LoRa. As a result, it is ensured that the first marking device of the discharge device can communicate with the corresponding transmitter/receiver units.

Furthermore, according to an example embodiment of the present invention, the process data of the printable material can comprise specific properties of the material, the specific properties of the material including the degree of degeneration and/or the viscosity number and/or the residual moisture. Thus, the material is qualified, in particular with respect to its chemical properties. The chemical properties of the material are verified and ensured prior to filling the discharge device, in order to provide the correct material for the corresponding printing process. Furthermore, the state of the material must be assessed with respect to its degree of degeneration or viscosity number, in order to ensure a stable printing process. Other material properties can be the degree of drying or the residual moisture of the material. For multi-component materials, the glass fiber distribution must be taken into account.

Furthermore, according to an example embodiment of the present invention, the process data of the three-dimensional object can comprise specific properties of the three-dimensional object, the specific properties of the three-dimensional object including at least movement profiles for producing the three-dimensional object.

Further validated process data result from printing prototypes and test prints with corresponding materials, as a result of which print data are collected and evaluated, for example, with respect to the resulting print results. These data comprise parameters for the process data with respect to the material and the component to be printed, such as the printing temperature and movement profiles. Furthermore, validated process data such as possible length compensation of the discharge device or the cartridge due to the printing force and/or the shrinkage of the material during extrusion can improve the print quality.

The present invention further comprises a method for printing a three-dimensional object from the printable material by means of a system according to the present invention for printing the three-dimensional object.

According to the present invention, in a first exemplary embodiment of the method, process data of the printable material and/or the three-dimensional object are stored by the second marking device of the dosing device on a storage unit of the first marking device of the discharge device prior to, during or after a filling process of the discharge device by means of the dosing device and are read out from the first marking device of the discharge device by the third marking device of the printing device prior to the printing of the three-dimensional object.

Storing the process data on a storage unit of the discharge device allows the process parameters to be directly assigned to the particular discharge device. Advantageously, the data can be read out directly from the storage unit. Thus, features related to printing are located directly on the cartridge.

According to the present invention, in a second exemplary embodiment of the method, process data of the printable material and/or the three-dimensional object are stored in a network or in a cloud, wherein they are assigned to the particular printable material and/or the three-dimensional object by an identification code stored on the first marking device of the discharge device.

Storing the process data in a network or in a cloud advantageously allows secure storage of the data. Direct assignment of the process parameters to the particular discharge device is possible by means of the identification code stored on the first marking device. Advantageously, the data can be loaded from the network or cloud and, if applicable, processed without physical contact.

In a development of the second exemplary embodiment of the method of the present invention, the process data of the printable material and/or the three-dimensional object are stored in the network and/or in the cloud prior to, during or after a filling process of the discharge device by means of the dosing device and are assigned to the identification code stored on the first marking device of the discharge device, wherein the second marking device of the dosing device identifies the first marking device of the discharge device.

Furthermore, the clearly identifiable and coded discharge device advantageously supports the user in preventing product piracy and the production of counterfeits. Furthermore, the discharge device allows the integration of a printing system into the “Internet of Things” and offers advantages with respect to digitalized production in “Industry 4.0” while maintaining quality and corresponding manufacturing standards.

The digitalization of the printing system allows the collection of data within a manufacturing platform and advantageously allows the analysis of process data or printer data with respect to their current and future application. The process parameters or data generated and recorded during printing can be used to replace or optimize old data. The data thus collected allow advantageous documentation of the life cycle of a product.

Another advantage of the present invention is that one or more components or products can be stored on the cartridge. The customer can retrieve and print these on his printer. As a result, advantageously, user-friendliness is significantly improved, and the qualification of the material and the printing process is greatly simplified.

As a result, individual components no longer need to be manufactured, stored, measured, and shipped in advance; rather, only the discharge devices or cartridges with the necessary stored data are required. This is particularly interesting if quantities are very small and there is a high degree of variance in the components.

In a development of the second exemplary embodiment of the method of the present invention, prior to the printing of the three-dimensional object, the identification code of the first marking device of the discharge device is read out by the third marking device of the printing device and the process data of the printable material and/or the three-dimensional object that are assigned to the read-out identification code are loaded from the network or the cloud and processed.

In a development of the second exemplary embodiment of the method of the present invention, process data recorded during the printing of the three-dimensional object are stored in the printing device and, after the printing of the three-dimensional object, the new process data are allocated to the identification code of the first marking device of the discharge device and, by means of the third marking device of the printing device, are sent to the network or the cloud, and are stored and processed.

The ascertainment of new process data that arise during the printing process, which can be detected, for example, via sensors, and the clear assignment of these process data of the printable material and/or the three-dimensional object to the discharge device advantageously allows a comparison of the existing with the new process data and a possible optimization of future process data.

Exemplary embodiments of the present invention are illustrated in the figures and explained in more detail in the following description.

### BRIEF DESCRIPTION OF THE DRAWINGS

FIG. 1 shows an example of a device during filling of a discharge device according to the related art.

FIG. 2 shows an example of a printing device with a plurality of discharge units arranged in different printing chamber units according to the related art.

FIG. 3 shows a device for providing a material to be printed according to a first exemplary embodiment of the present invention.

FIG. 4 shows a device for providing a material to be printed according to a second exemplary embodiment of the present invention.

FIG. 5 shows a printing device according to a first exemplary embodiment of the present invention.

FIG. 6 shows a printing device according to a second exemplary embodiment of the present invention.

FIG. 7 shows a system for printing a three-dimensional object, according to an example embodiment of the present invention.

FIG. 8 shows a 3D printer with a discharge device, according to an example embodiment of the present invention.

FIG. 9 shows an example of an object, according to an example embodiment of the present invention.

### DETAILED DESCRIPTION OF EXAMPLE EMBODIMENTS

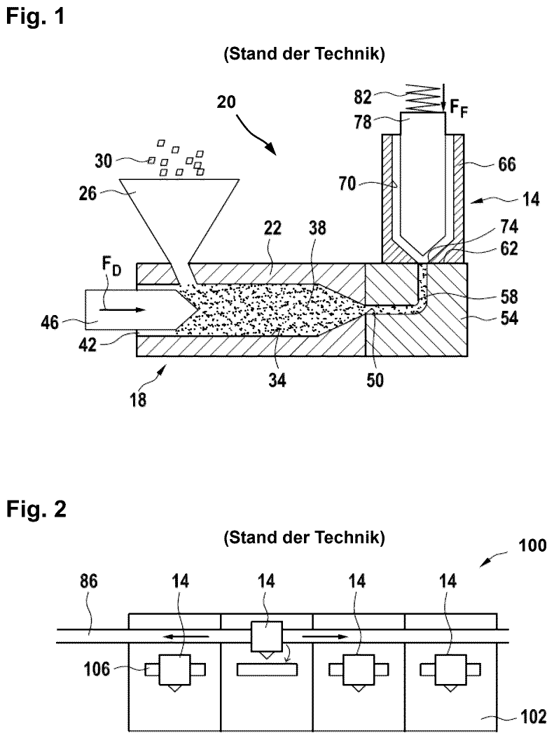

FIG. 1 shows an example of a device 20 from the related art for providing a material 38 to be printed during filling of a discharge device 14. FIG. 1 is a sectional view of the device 20. The device 20 comprises a dosing device 18 in addition to the discharge device 14. The dosing device 18 is formed from a main body 22 on which a filling funnel 26 is arranged. A raw material 30, which is in solid form, in particular in the form of granules, can be filled into the filling funnel 26. The filling funnel 26 is directly connected to a dosing chamber 34 formed by the main body 22. In this dosing chamber 34, the raw material 30 is melted and plasticized to form a printable material 38.

The dosing chamber 34 comprises a lateral dosing piston opening 42. In this dosing piston opening 42, a dosing piston 46 is arranged, which projects into the dosing chamber 34. A dosing piston force F_{D} can be applied to the material 38 in the dosing chamber 34 via the dosing piston 46, so that said material can be pressed in the direction of a dosing delivery opening 50 located opposite the dosing piston opening 42.

At the dosing delivery opening 50, the dosing device 18 comprises a coupling element 54 that forms a channel 58, so that the material 38 discharged via the dosing delivery opening 50 can be conveyed to a coupling point 62 of the coupling element 54. The discharge device 14 is arranged at the coupling point 62, so that this discharge device 14 can receive the melted material 38.

The discharge device 14 comprises a discharge body 66 that forms a discharge chamber 70, in which melted material 38 can be received. At an end of the discharge body 66 connected to the coupling point 62, a nozzle 74 is formed via which the melted material 38 can be received. Likewise, the material 38 is applied to a workpiece (not shown) through this nozzle 74.

A discharge piston 78 is arranged within the discharge chamber 70, via which discharge piston the material 38 can be discharged. Above the discharge piston 78, a means 82 is arranged via which a force FF is applied against a filling direction during filling. In this exemplary embodiment, the means 82 is designed as a schematically indicated spring. Due to the force FF exerted on the discharge piston 78, filling of the discharge device 14 without air is ensured. During filling, the discharge piston 78 is displaced in the direction of the spring 82.

FIG. 2 shows an example of a printing device 100 with a plurality of discharge units 14, which are arranged in different printing chamber units 102 according to the related art. Each printing chamber unit 102 produces a different workpiece. In each printing chamber unit 102, a discharge unit 14 is arranged, which in each case is received by a print head body 106, over which the discharge unit 14 is movable.

The printing device 100 comprises a transport system 86. Accordingly, a plurality of discharge units 14 can be connected to one another via a single transport system 86. As a result, the utilization of the printing device 100 can be improved.

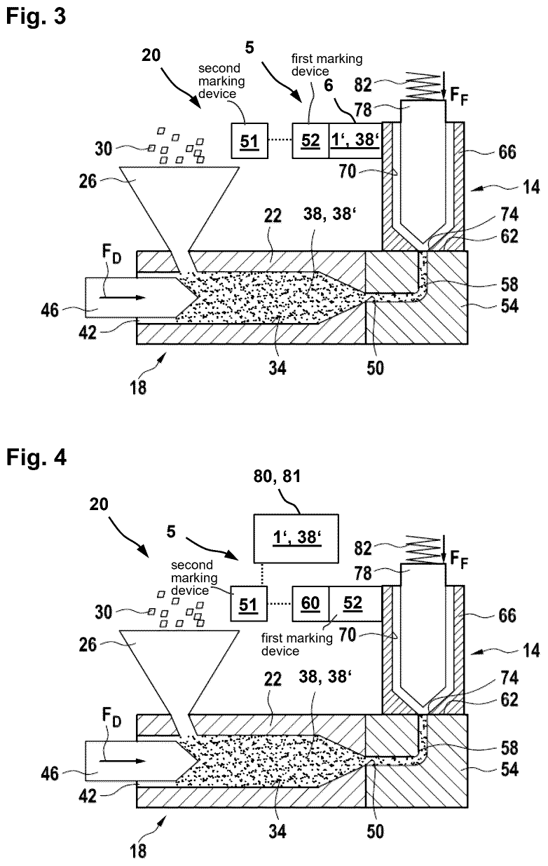

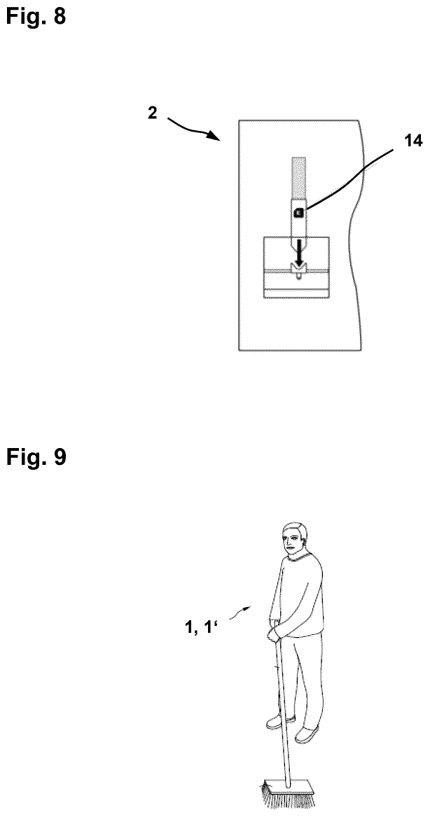

FIG. 3 and FIG. 4 each show an exemplary embodiment of a device 20 for providing a material 38 to be printed for producing a three-dimensional object 1 to be printed from the printable material 38, which object is shown by way of example in FIG. 9, for a 3D printer 2 shown in FIG. 8, said device comprising a dosing device 18 for filling a discharge device 14 with the material 38.

The device 20 comprises a system 5 for identifying the printable material 38 and/or the three-dimensional object 1 using a marking device 52, wherein the discharge device 14 comprises a first marking device 52 and the dosing device 18 comprises a second marking device 51. The basic structure of the device 20 for providing the material 38 to be printed corresponds to the structure of the device in FIG. 1. In both exemplary embodiments, the identification system 5 is designed in such a way that process data 38′, 1′ of the printable material 38 and/or the three-dimensional object 1 can be clearly assigned to the particular discharge device 14.

The process data 38′ of the printable material 38 comprise specific properties of the material 38, the specific properties of the material 38 including the degree of degeneration and/or the viscosity number and/or the residual moisture.

The process data 1′ of the three-dimensional object 1 comprise specific properties of the three-dimensional object 1, the specific properties of the three-dimensional object 1 including at least movement profiles for producing the three-dimensional object 1.

In order to ensure the high forces in the dosing device 18, the dosing device 18 preferably comprises the dosing piston 46 for discharging the material 38 from the dosing device 18, which dosing piston is driven by a hydraulic or an electric motor. The dosing piston 46 is movably arranged in the dosing device 18 and exerts a force F_{D} on the material 38 in the dosing device 18, in order to transport this material 38 from the dosing device 18 into the discharge device 14. In contrast to the discharge device 14, where a high degree of precision is necessary, sufficient forces can thus be provided in the dosing device 18. Due to the separation of the discharge device 14 from the dosing device 18, each device 20 can be optimized in terms of function. When connecting the dosing device 18 to the discharge device 14, the two devices are connected to one another in a sealing manner, so that the material 38 can be transferred from the dosing device 18 to the discharge device 14.

The dosing device 18 for filling the discharge device 14 is designed, for example, in such a way that the material 38 to be printed is melted prior to the filling of the discharge device 14 and the plasticized material 38 can be introduced into the discharge device 14 via an opening 74. Furthermore, the dosing device 18 for filling the discharge device 14 can also be designed in such a way that the material 38 to be printed is compacted prior to the filling of the discharge device 14 and the compacted material 38 can be introduced into the discharge device 14 via an opening 74.

FIG. 3 shows a first exemplary embodiment of the dosing device 18 of the system 40 according to the present invention with the device 20 for filling the discharge device 14, wherein the process data 38′, 1′ are stored in a storage unit 6 of the first marking device 52, wherein the storage unit 6 is arranged on the discharge device 14.

The first marking device 52 of the discharge device 14 is suitable for mutual communication with the second marking device 51 of the dosing device 18. The first marking device 52 can be read out via the second marking device 51, which is, for example, a receiver unit for wireless communication, wherein the first marking device 52 is designed in such a way that process data 38′, 1′ can be transmitted, for example, via WLAN, RFID, NFC, Bluetooth or LoRa.

In a method for providing the material 38 to be printed for producing the three-dimensional object 1 to be printed from the printable material 38 for a 3D printer 2 with the device 20 shown in FIG. 3, process data 38′, 1′ of the printable material 38 and/or the three-dimensional object 1 are stored by the second marking device 51 of the dosing device 18 on the storage unit 6 of the first marking device 52 of the discharge device 14 prior to, during or after a filling process of the discharge device 14 by means of the dosing device 18.

FIG. 4 shows a second exemplary embodiment of the dosing device 18 of the system 40 with the device 20 for filling the discharge device 14, wherein the process data 38′, 1′ are stored in a network 80 or in a cloud 81, wherein they can be assigned to the particular printable material 38 and/or the three-dimensional object 1 via an identification code 60 stored on the first marking device 52. The first marking device 52 can be read out optically or via the second marking device 51, which is, for example, a receiver unit for wireless communication, wherein the marking device 52 comprises, for example, a QR code or a barcode.

In a method for providing the material 38 to be printed for producing the three-dimensional object 1 to be printed from the printable material 38 for a 3D printer 2 with the device 20 shown in FIG. 4, process data 38′, 1′ of the printable material 38 and/or the three-dimensional object 1 are stored in a network 80 and/or in a cloud 81, wherein they are assigned to the particular printable material 38 and/or the three-dimensional object 1 by an identification code 60 stored on the first marking device 52 of the discharge device 14.

The process data 38′, 1′ of the printable material 38 and/or the three-dimensional object 1 are stored in the network 80 and/or in the cloud 81 prior to, during or after a filling process of the discharge device 14 by means of the dosing device 18 and are assigned to the identification code 60 stored on the first marking device 52 of the discharge device 14, wherein the second marking device 51 0 4 the dosing device 18 identifies the first marking device 52 of the discharge device 14.

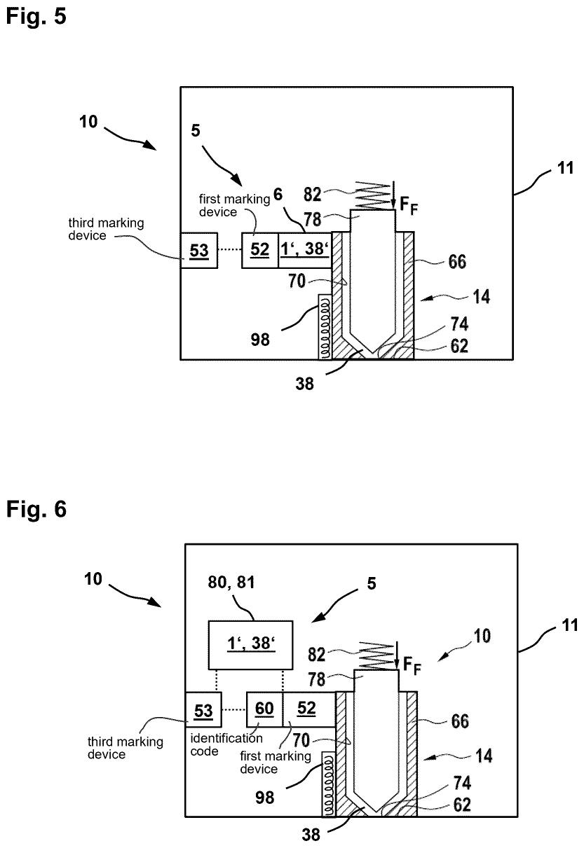

FIG. 5 and FIG. 6 each show an exemplary embodiment of a printing device 10 of the system 40 according to the present invention for printing a material 38 to be printed for producing a three-dimensional object 1 to be printed from the printable material 38, which object is shown by way of example in FIG. 9, for a 3D printer 2 shown in FIG. 8, said printing device comprising a discharge device 14 with the material 38 and a receiving device 11 for receiving the discharge device 14.

The printing device 10 comprises a system 5 for identifying the printable material 38 and/or the three-dimensional object 1, wherein the first marking device 52 is arranged on the discharge device 14 and a third marking device 53 is arranged on the printing device 10.

The basic structure of the printing device 10 for printing the material 38 to be printed provides that the receiving device 11 of the printing device 10 receives the discharge device 14 and the second marking device 53 of the printing device 10. The discharge unit 14 comprises the discharge body 66, which forms the discharge chamber 70, in which the melted material 38 can be received. At the end of the discharge body 66, the nozzle 74 is formed, via which the molten material 38 can be discharged from the discharge body 66.

For melting the material 38 in the discharge device 14, the printing device 10 comprises a heater 98 on the receiving device 11, which heater is arranged on the discharge device 14.

The discharge piston 78, via which the material 38 can be discharged, is arranged within the discharge chamber 70. Above the discharge piston 78, a means 82 for dispensing material 38 from the discharge device 14 is arranged. The discharge piston 78 interacts with the means 82 in such a way that a force FF for dispensing material 38 from the discharge device 14 can be applied. The means 82 for dispensing material 38 can be operated hydraulically or electrically.

Furthermore, in both exemplary embodiments, the identification system 5 is designed in such a way that process data 38′, 1′ of the printable material 38 and/or the three-dimensional object 1 can be clearly assigned to the particular discharge device 14. The process data 38′ of the printable material 38 comprise specific properties of the material 38, the specific properties of the material 38 including the degree of degeneration and/or the viscosity number and/or the residual moisture.

The process data 1′ of the three-dimensional object 1 comprise specific properties of the three-dimensional object 1, the specific properties of the three-dimensional object 1 including at least movement profiles for producing the three-dimensional object 1.

FIG. 5 shows a first exemplary embodiment of the system 40 according to the present invention with the printing device 10, wherein the process data 38′, 1′ are stored in a storage unit 6 of the first marking device 52, wherein the storage unit 6 is arranged on the discharge device 14.

The first marking device 52 of the discharge device 14 is suitable for mutual communication with the third marking device 53 of the printing device 10. The first marking device 52 can be read out via the third marking device 53, which represents, for example, a receiver unit for wireless communication, wherein the first marking device 52 is designed in such a way that process data 38′, 1′ can be transmitted, for example, via WLAN, RFID, NFC, Bluetooth or LoRa.

The method for printing a material 38 to be printed for producing a three-dimensional object 1 to be printed from the printable material 38 for a 3D printer 2 with the printing device 10 shown in FIG. 5 provides that process data 38′, 1′ of the printable material 38 and/or the three-dimensional object 1 are read out from the storage unit 6 of the first marking device 52 of the discharge device 14 by the third marking device 53 of the printing device 10 prior to the printing of the three-dimensional object 1.

FIG. 6 shows a second exemplary embodiment of the system 40 according to the present invention with the printing device 10, wherein the process data 38′, 1′ are stored in a network 80 or in a cloud 81, wherein they can be assigned to the particular printable material 38 and/or the three-dimensional object 1 via an identification code 60 stored on the first marking device 52. The first marking device 52 of the discharge device 14 is suitable for mutual communication with the third marking device 53 of the printing device 10. The first marking device 52 can be read out optically or via the third marking device 53, which is, for example, a receiver unit for wireless communication, wherein the marking device 52 comprises, for example, a QR code or a barcode.

In the method for printing the material 38 to be printed for producing the three-dimensional object 1 to be printed from the printable material 38 for a 3D printer 2 with the printing device 10 shown in FIG. 6, process data 38′, 1′ of the printable material 38 and/or the three-dimensional object 1 are stored in a network 80 and/or in a cloud 81, wherein they are assigned to the particular printable material 38 and/or the three-dimensional object 1 by an identification code 60 stored on the first marking device 52 of the discharge device 14.

Prior to the printing of the three-dimensional object 1, the identification code 60 of the first marking device 52 of the discharge device 14 is read out by the third marking device 53 of the printing device 10 and the process data 38′, 1′ of the printable material 38 and/or the three-dimensional object 1 that are assigned to the read-out identification code 60 are loaded from the network 80 or the cloud 81 and processed.

During the printing of the three-dimensional object 1, new process data 38′, 1′ of the printable material 38 and/or the three-dimensional object 1 are ascertained by the printing device 10. Subsequently, after printing, they are assigned to the identification code 60 of the discharge device 14 by the third marking device 53 of the printing device 10 and the process data 38′, 1′ are then, by means of the third marking device 53, loaded into the network 80 or into the cloud 81 and processed.

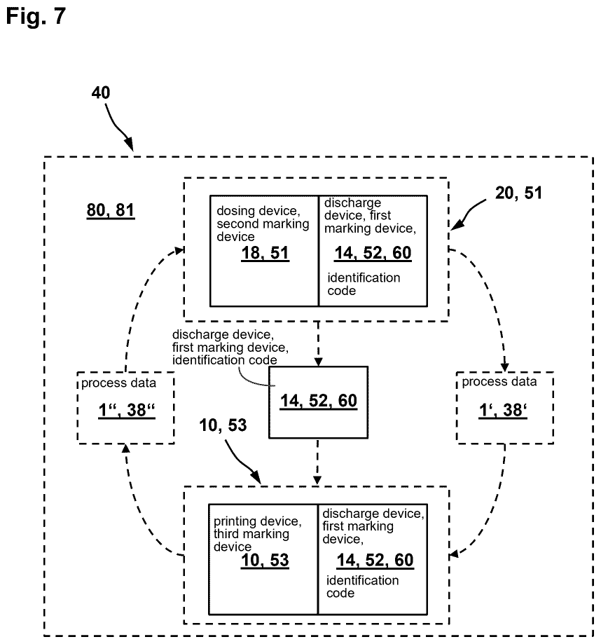

FIG. 7 shows the system 40 according to the present invention for printing the three-dimensional object 1. The system 40 for printing the three-dimensional object 1 from the printable material 38 comprises the printing device 10 for a 3D printer 2, the dosing device 18 for filling the material 38 to be printed and the discharge device 14 for printing the material 38 provided via the dosing device 18, wherein the discharge device 14 comprises the first marking device 52 for identifying the printable material 38 and/or the three-dimensional object 1. The dosing device 18 comprises the second marking device 51. The printing device 10 comprises the third marking device 53.

The system 40 is designed in such a way that process data 38′, 1′ of the printable material 38 and/or the three-dimensional object 1 can be clearly assigned to the particular discharge device 14. The process data 38′, 1′ are stored in the cloud 81, wherein they can be assigned to the particular printable material 38 and/or the three-dimensional object 1 via the identification code 60 stored on the first marking device 52.

The first marking device 52 of the discharge device 14 is suitable for mutual communication with the second marking device 51 of the dosing device 18 and for mutual communication with the third marking device 53 of the printing device 10.

The method for printing a three-dimensional object 1 from a printable material 38 by means of the system 40 is carried out by storing process data 38′, 1′ of the printable material 38 and/or the three-dimensional object 1 in the network 80 or in a cloud 81, wherein they are assigned to the particular printable material 38 and/or the three-dimensional object 1 by an identification code 60 stored on the first marking device 52 of the discharge device 14.

Furthermore, in a further method step of the method, process data 38′, 1′ of the printable material 38 and/or the three-dimensional object 1 are stored in the network 80 or in the cloud 81 prior to, during or after a filling process of the discharge device 14 by means of the dosing device 18 and are assigned to the identification code 60 stored on the first marking device 52 of the discharge device 14, wherein the second marking device 51 of the dosing device 18 identifies the first marking device 52 of the discharge device 14.

In a further method step of the method, prior to the printing of the three-dimensional object 1, the identification code 60 of the first marking device 52 of the discharge device 14 is read out by the third marking device 53 of the printing device 10 and the process data 38′, 1′ of the printable material 38 and/or the three-dimensional object 1 that are assigned to the read-out identification code 60 are loaded from the network 80 or the cloud 81 and processed.

Subsequently, in a next method step, process data 38″, 1″ recorded during the printing of the three-dimensional object 1 are stored in the printing device 10 and, after the printing of the three-dimensional object 1, the new process data 38″, 1″ are allocated to the identification code 60 of the first marking device 52 of the discharge device 14 and, by means of the third marking device 53 of the printing device 10, are sent to the network 80 or the cloud 81, and are stored and processed.

These data 38″, 1″ can then be allocated to a discharge device 14 for a new filling process.

FIG. 8 shows the 3D printer 2 with a discharge device 14 and in FIG. 9 an example of the object 1 is shown in a schematic perspective drawing.

1-11. (canceled)

12. A system for printing a three-dimensional object from a printable material, the system comprising:
a printing device for a 3D printer;
a dosing device configured to fill the material to be printed; and
a discharge device configured to print the material provided via the dosing device, wherein the discharge device includes a first marking device configured to identify the printable material and/or the three-dimensional object.

13. The system according to claim 12, wherein the dosing device includes a second marking device.

14. The system according to claim 13, wherein the printing device includes a third marking device.

15. The system according to claim 12, wherein the system is configured in such a way that process data of the printable material and/or of the three-dimensional object, can be clearly assigned to the discharge device.

16. The system according to claim 15, wherein: (i) the process data are stored in a storage unit of the first marking device, and the storage unit is arranged on the discharge device, or (ii) the process data are stored in a network or in a cloud (81), wherein the process data can be assigned to the printable material and/or the three-dimensional object via an identification code stored on the first marking device.

17. The system according to claim 14, wherein the first marking device of the discharge device is configured for mutual communication with the second marking device of the dosing device and for mutual communication with the third marking device of the printing device.

18. A method for printing a three-dimensional object from a printable material by a system including:
a printing device for a 3D printer,
a dosing device configured to fill the material to be printed, and
a discharge device configured to print the material provided via the dosing device, wherein the discharge device includes a first marking device configured to identify the printable material and/or the three-dimensional object,
wherein the dosing device includes a second marking device, and
wherein the printing device includes a third marking device;
the method comprising:
prior to, or during, or after a filling process of the discharge device using the dosing device, storing process data of the printable material and/or the three-dimensional object, by the second marking device of the dosing device on a storage unit of the first marking device of the discharge device; and
reading out the stored proces data from the first marking device of the discharge device by the third marking device of the printing device prior to the printing of the three-dimensional object.

19. A method for printing a three-dimensional object from a printable material using a a system including:
a printing device for a 3D printer,
a dosing device configured to fill the material to be printed, and
a discharge device configured to print the material provided via the dosing device, wherein the discharge device includes a first marking device configured to identify the printable material and/or the three-dimensional object;
the method comprising:
storing process data of the printable material and/or the three-dimensional object in a network or in a cloud; and
assigning the process data to the printable material and/or the three-dimensional object, by an identification code stored on the first marking device of the discharge device.

20. The method according to claim 19, wherein the dosing device includes a second marking device, and wherein the process data of the printable material and/or the three-dimensional object are stored in the network or in the cloud prior to, or during, or after a filling process of the discharge device using the dosing device and are assigned to the identification code stored on the first marking device of the discharge device, wherein the second marking device of the dosing device identifies the first marking device of the discharge device.

21. The method according to claim 20, wherein the printing device includes a third marking device, and wherein prior to the printing of the three-dimensional object, the identification code of the first marking device of the discharge device is read out by the third marking device of the printing device, and the process data of the printable material and/or the three-dimensional object that are assigned to the read-out identification code are loaded from the network or the cloud and processed.

22. The method according to claim 21, wherein new process data recorded during the printing of the three-dimensional object are stored in the printing device, and, after the printing of the three-dimensional object, the new process data are allocated to the identification code of the first marking device of the discharge device, and, using the third marking device of the printing device, are sent to the network or the cloud, and are stored and processed.
